(19) United States
(12) Patent Application Publication
(10) Pub. No.: US 2012/0135318 A1
(43) Pub. Date: May 31, 2012

(54) POSITIVE ACTIVE MATERIAL FOR RECHARGEABLE LITHIUM BATTERY AND RECHARGEABLE LITHIUM BATTERY COMPRISING SAME

(75) Inventors: Jae-Hyuk KIM, Yongin-si (KR); Sung-Hwan Moon, Yongin-si (KR); Matulevich Yuri, Yongin-si (KR); Myung-Hwan Jeong, Yongin-si (KR); Hee-Young Chu, Yongin-si (KR); Chang-Ui Jeong, Yongin-si (KR); Joo-Han Song, Yongin-si (KR); Jong-Seo Choi, Yongin-si (KR)

(73) Assignee: Samsung SDI Co., Ltd., Yongin-si (KR)

(21) Appl. No.: 13/217,574

(22) Filed: Aug. 25, 2011

(30) Foreign Application Priority Data
Nov. 25, 2010 (KR) 10-2010-0118330

(51) Int. Cl. H01M 4/58; H01M 4/525; H01M 10/056; H01M 4/583; H01M 4/48; H01M 10/00; H01M 4/505

(52) U.S. Cl. 429/341; 429/231.95; 429/223; 429/224; 429/231.3; 429/221; 429/220; 429/231.8; 429/324; 429/231.5; 429/231.2; 252/182.1

(57) ABSTRACT

Disclosed is a positive active material for a rechargeable lithium battery, which includes an active material capable of reversibly intercalating/deintercalating lithium and lithium polysulfide.

### CROSS-REFERENCE TO RELATED APPLICATIONS

This application claims priority to and the benefit of Korean Patent Application No. 10-2010-0118330 filed in the Korean Intellectual Property Office on Nov. 25, 2010, the entire contents of which are incorporated herein by reference.

### BACKGROUND

1. Field

The disclosure relates to a positive active material for a rechargeable lithium battery and a rechargeable lithium battery including the same.

2. Description of the Related Technology

Much research has been undertaken on increasing energy density to accomplish a rechargeable lithium battery with high-capacity

A great deal of attention has been made in an attempt to increase energy density of a battery by using Si-based oxide or Sn-based oxide, their alloy, and the like, which are known to have high capacity, as a negative active material. However, these negative active materials have a problem of severe initial irreversible capacity. It is necessary to use a positive active material having capacity in order to compensate the severe initial irreversible capacity of the negative active material,

Conventionally, a Li₂MoO₃ material may be mixed with a positive active material to compensate initial irreversible capacity but it has an unstable structure. Even though other elements are added to the Li₂MoO₃ material in order to improve stability of the Li₂MoO₃ material, this is not sufficient to achieve stability of the Li₂MoO₃ material. Accordingly, there are shortcomings, such as dissolution of Mo from the Li₂MoO₃ material during the repeated charge and discharge cycles. In addition, graphite, a conventional negative electrode material, has initial irreversible capacity ranging from 20 to 60% of the entire amount of Li which can be inserted into the graphite (J. Eloctrochem. Soc., Vol. 145, No. 4, April 1998) and thus, requires an extra Li source.

### SUMMARY

An example embodiment provides a positive active material for a rechargeable lithium battery, which may compensate irreversible capacity during the initial charge and discharge.

Another embodiment provides a rechargeable lithium battery having no aforementioned problem and realizing high-capacity.

Yet another embodiment provides a positive active material for a rechargeable lithium battery, which includes an active material capable of reversibly intercalating/deintercalating lithium; and lithium polysulfide.

The lithium polysulfide may be Li₂Sₓ (x is an integer of 1 to 8).

The active material capable of reversibly intercalating/deintercalating lithium may include one selected from the group consisting of LiₐA_{1-b}R_{b}D₂ (0.90≦a≦1.8 and 0≦b≦0.5); LiₐE_{1-b}R_{b}O_{2-c}D_{c} (0.90≦a≦1.8, 0≦b≦0.5 and 0≦c≦0.05); LiₐE_{2-b}R_{b}O_{4-c}D_{c} (0.90≦a≦1.8, 0≦b≦0.5, 0≦c<0.05); LiₐNi_{1-b-c}Co_{b}R_{c}D_{α} (0.90≦a≦1.8, 0≦b≦0.5, 0≦c≦0.05 and 0<α≦2); LiₐNi_{1-b-c}Co_{b}R_{c}O_{2-α}Z_{α} (0.90≦a≦1.8, 0≦b≦0.5, 0≦c≦0.05 and 0<α<2); LiₐNi_{1-b-c}Co_{b}R_{c}O_{2-α}Z₂ (0.90≦a≦1.8, 0≦b≦0.5, 0≦c≦0.05 and 0<α<2); LiₐNi_{1-b-c}Mn_{b}RₑD_{α} (0.90≦a≦1.8, 0≦b≦0.5, 0≦c≦0.05 and 0<α<2); LiₐNi_{1-b-c}Mn_{b}R_{c}O_{2-α}Z_{α} (0.90≦a≦1.8, 0≦b≦0.5, 0≦c≦0.05 and 0<α<2); LiₐNi_{1-b-c}Mn_{b}R_{c}O_{2-α}Z₂ (0.90≦a≦1.8, 0≦b≦0.5, 0≦c≦0.05 and 0<α<2); LiₐNi_{b}E_{c}G_{d}O₂ (0.90≦a≦1.8, 0≦b≦0.9, 0≦c≦0.5 and 0.001≦d≦0.1); LiₐNi_{b}Co_{c}Mn_{d}GeO₂ (0.90≦a≧1.8, 0≦b≦0.9, 0≦c≦0.5, 0≦d≦0.5 and 0.001≦e≦0.1); LiₐNiG_{b}O₂ (0.90≦a≦1.8 and 0.001≦b≦0.1); LiₐCoG_{b}O₂ (0.90≦a≦1.8 and 0.001≦b≦0.1); LiₐMnG_{b}O₂ (0.90≦a≦1.8 and 0.001≦b≦0.1); LiₐMn₂G_{b}O₄ (0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); LiFePO₄, or a combination thereof. In the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

The active material capable of reversibly intercalating/deintercalating lithium may include lithium cobalt-based oxide, lithium manganese-based oxide, or a combination thereof.

A particle of the lithium polysulfide may have a diameter (X) determined by the following Equation 1.

2r(\sqrt{2}−1)≦X≦2r(\sqrt{2}−1)+2r(\sqrt{2}−1)×K [Equation 1]

In the above Equation 1,

r is the radius of a active material capable of reversibly intercalating/deintercalating lithium, and K is a volume reduction ratio when lithium polysulfide is converted into sulfur.

The lithium polysulfide may have a weight average molecular weight ranging from 45.95 to 270.40. The lithium polysulfide may cover from Li₂S including the most lithium per sulfur unit to Li₂S₈ including the least lithium per sulfur unit and play a role of supplying extra lithium.

According to another embodiment, provided is a rechargeable lithium battery including a negative electrode including a negative active material; a positive electrode including the positive active material; and a non-aqueous electrolyte.

In the positive active material, the active material capable of reversibly intercalating/deintercalating lithium and the lithium polysulfide may be mixed in a weight ratio determined by the following Equation 2.

Y:Z=D/E:[(A×B)/((100−B)×C}]±20% [Equation 2]

In the above Equation 2,

Y indicates the amount of an active material capable of reversibly intercalating/deintercalating lithium, and Z indicates the amount of lithium polysulfide,

A indicates a negative active material capacity (mAh) required in a battery, B indicates a negative active material irreversible capacity ratio (%), D indicates design capacity (mAh), E indicates the theoretical specific capacity (mAh/g) of an active material capable of reversibly intercalating/deintercalating lithium, and C indicates the theoretical capacity (mAh/g) of lithium polysulfide.

The negative active material may be selected from the group consisting of graphite, silicon (Si), silicon-based oxide, tin, tin-based oxide, and a combination thereof.

The embodiment may provide a rechargeable lithium battery being compensated for initial irreversible capacity and having excellent charge and discharge capacity and cycle characteristic.

### BRIEF DESCRIPTION OF THE DRAWINGS

FIG. 1 provides a drawing schematically showing the structure of a rechargeable lithium battery according to one embodiment.

FIG. 2 provides a graph showing charge/discharge capacity change depending on the added amount of lithium polysulfide.

### DETAILED DESCRIPTION

Example embodiments will hereinafter be described in detail. However, these embodiments are only examples, and the present embodiments are not limited thereto.

According to one embodiment, provided is a positive active material for a rechargeable lithium battery, which includes an active material capable of reversibly intercalating/deintercalating lithium and lithium polysulfide.

The lithium polysulfide may be used for an irreversible material generated from the irreversible reaction of lithium during the initial charge and discharge and compensate capacity deterioration due to generation of the irreversible material.

The lithium polysulfide may be added to a positive active material with high-capacity and for example, include Li₂S. The Li₂S has 1141.6 mAh/g of theoretical capacity, which is four times greater than the 273 mAh/g of theoretical capacity of lithium cobalt-based oxide and seven times greater than the 150 mAh/g of actual capacity of the lithium cobalt-based oxide.

In addition, the lithium polysulfide has large capacity per volume as a positive active material. For example, it has twice the capacity of lithium cobalt-based oxide. Accordingly, the lithium polysulfide may be included in a smaller volume to accomplish desired battery capacity. The same volume of the lithium polysulfide may bring about bigger capacity improvement. The lithium polysulfide may be controlled regarding the amount added to acquire the desired capacity.

The lithium polysulfide has a standard reduction potential of about 2.1V against Li/Li⁺, which is a relatively low value, and is lower than a positive active material with reduction potential of more than or equal to 3V such as lithium cobalt-based oxide, lithium manganese-based oxide, and the like and thus, it has lower an oxidation and reduction potential than the other positive active materials, after fabricating a battery. Thus, lithium may be initially deintercalted from lithium polysulfide. Accordingly, the lithium polysulfide may work as a Li ion source for solving an initial irreversible capacity problem.

The lithium polysulfide may, for example, Li₂Sₓ (x is an integer of 1 to 8). In another embodiment, the lithium polysulfide may be Li₂S.

The active material capable of reversibly intercalating/deintercalating lithium may be a compound including Li. For example, it may include at least one composite oxide of a metal such as cobalt, manganese, nickel, or a combination thereof with lithium, or, a compound represented by one of the following formulas. LiₐA_{1-b}R_{b}D₂ (0.90≦a≦1.8 and 0≦b≦0.5); LiₐE_{1-b}R_{b}O_{2-c}D_{c} (0.90≦a≦1.8, 0≦b≦0.5 and 0≦c≦0.05); LiₐE_{2-b}R_{b}O_{4-c}D_{c} (0.90≦a≦1.8, 0≦b≦0.5, 0≦c≦0.05); LiₐNi_{1-b-c}Co_{b}R_{c}D_{α} (0.90≦a≦1.8, 0≦b≦0.5, 0≦c≦0.05 and 0<α≦2); LiₐNi_{1-b-c}Co_{b}R_{c}O_{2-α}Z_{α} (0.90≦a≦1.8, 0≦b≦0.5, 0≦c≦0.05 and 0<α<2); LiₐNi_{1-b-c}Co_{b}R_{c}O_{2-α}Z₂ (0.90≦a≦1.8, 0≦b≦0.5, 0≦c≦0.05 and 0<α<2); LiₐNi_{1-b-c}Mn_{b}R_{c}D_{α} (0.90≦a≦1.8, 0≦b≦0.5, 0≦c≦0.05 and 0<α≦2); LiₐNi_{1-b-c}Mn_{b}R_{c}O_{2-α}Z_{α} (0.90≦a≦1.8, 0≦b≦0.5, 0≦c≦0.05 and 0<α<2); LiₐNi_{1-b-c}Mn_{b}R_{c}O_{2-α}Z₂ (0.90≦a≦1.8, 0≦b≦0.5, 0≦c≦0.05 and 0<α<2); LiₐNi_{b}E_{c}G_{d}O₂ (0.90≦a≦1.8, 0≦b≦0.9, 0≦c≦0.5 and 0.001≦d≦0.1); LiₐNi_{b}Co_{c}Mn_{d}GeO₂ (0.90≦a≦1.8, 0≦b≦0.9, 0≦c≦0.5, 0≦d≦0.5 and 0.001≦e≦0.1); LiₐNiG_{b}O₂ (0.90≦a≦1.8 and 0.001≦b≦0.1); LiₐCoG_{b}O₂ (0.90≦a≦1.8 and 0.001≦b≦0.1); LiₐMnG_{b}O₂ (0.90≦a≦1.8 and 0.001≦b≦0.1); LiₐMn₂G_{b}O₄ (0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); LiFePO₄, or a combination thereof.

In the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

The active material can have a coating layer on the surface or can be mixed with a compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxy carbonate of a coating element. The compounds for a coating layer may be amorphous or crystalline. The coating element for a coating layer may include Mg, Al, Co, K, Na, Ca, Si, Ti, V, Sn, Ge, Ga, B, As, Zr, or a mixture thereof. The coating layer can be formed in any method having no negative influence on properties of a positive active material by adding these elements to the compound. For example, the method may include any coating method such as spray coating, dipping, and the like, but is not illustrated in more detail since it is well-known to a skilled person in the related field.

In one embodiment, the active material capable of reversibly intercalating/deintercalating lithium may include lithium cobalt-based oxide, lithium manganese-based oxide, lithium nickel cobalt manganese-based oxide, and a combination thereof. In another embodiment, lithium cobalt-based oxide and lithium nickel-based oxide, and the like may be preferable.

In another embodiment, a positive electrode include a current collector and a positive active material layer on the current corrector. The positive active material includes the positive active material, and may include a binder and a conductive material.

The binder improves binding properties of the positive active material particles to each other and to a current collector. Examples of the binder include at least one of polyvinylalcohol, carboxylmethylcellulose, hydroxypropylcellulose, diacetylcellulose, polyvinylchloride, a carboxylated polyvinylchloride, polyvinylfluoride, apolymer including ethylene oxide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

Any electrically conductive material may be used as a conductive material unless it causes a chemical change. Examples of the conductive material include: carbon-based materials such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; and mixtures thereof.

The lithium polysulfide may be controlled regarding particle sizes to increase volume energy density of the positive active material. According to one embodiment, lithium polysulfide particle may have a diameter (X) satisfying the following Equation 1, wherein r is the radius of the active material capable of reversibly intercalating/deintercalating lithium, and a volume reduction ratio is K when lithium polysulfide is converted into sulfur.

2r(\sqrt{2}−1)≦X≦2r(\sqrt{2}−1)+2r(\sqrt{2}−1)×K [Equation 1]

For example, since Li₂S has a volume reduction ratio of 54.8%, K=0.548.

According to the embodiment, when the Li₂S is controlled regarding particle size and compressed to have high packing density, a positive active material may have improved capacity with the same volume.

The lithium polysulfide having a low weight average molecular weight compound is desired, since it may compensate big irreversible capacity in a small amount, increasing capacity of a positive active material. According to another embodiment, the lithium polysulfide may have a weight average molecular weight ranging from 45.95 to 270.40.

Another embodiment provides a rechargeable lithium battery including the positive active material for a rechargeable lithium battery.

The rechargeable lithium battery may include a negative electrode including a negative active material; a positive electrode including the aforementioned positive active material; and a non-aqueous electrolyte.

Rechargeable lithium batteries may be classified into lithium ion batteries, lithium ion polymer batteries, and lithium polymer batteries according to the presence of a separator and the kind of electrolyte used in the battery. The rechargeable lithium batteries may have a variety of shapes and sizes, and include cylindrical, prismatic, or coin-type batteries, and may be thin film batteries or may be rather bulky in size. The structure and the fabrication method for lithium ion batteries are well known in the art and will not be illustrated.

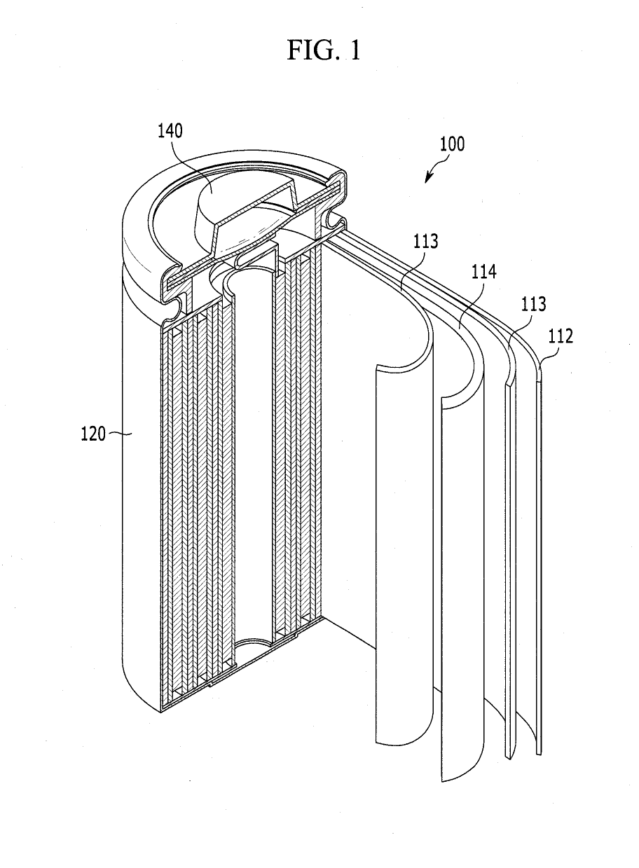

FIG. 1 is an exploded perspective view of a rechargeable lithium battery according to one embodiment. FIG. 1 illustrates a cylindrical rechargeable lithium battery 100, which includes a negative electrode 112, a positive electrode 114, a separator 113 interposed between the negative electrode 112 and the positive electrode 114, an electrolyte (not shown) impregnating the separator 113, a battery case 120, and a sealing member 140 sealing the battery case 120. The negative electrode 112, positive electrode 114, and separator 113 are sequentially stacked, spirally wound, and placed in a battery case 120 to fabricate such a rechargeable lithium battery 100.

The negative electrode includes a current collector and a negative active material layer disposed on the current collector. The negative active material layer includes a negative active material.

The negative active material may include a material that reversibly intercalates/deintercalates lithium ions, a lithium metal, a lithium metal alloy, a material capable of doping and dedoping lithium, or a transition metal oxide.

The material that reversibly intercalates/deintercalates lithium ions includes a carbon material. The carbon material may be any generally-used carbon-based negative active material for a lithium ion rechargeable battery. Examples of the carbon material include crystalline carbon, amorphous carbon, or a mixture thereof. The crystalline carbon may be non-shaped, or sheet, flake, spherical, or fiber shaped natural graphite or artificial graphite. The amorphous carbon may be a soft carbon, a hard carbon, mesophase pitch carbonized products, fired coke, or the like.

Examples of the lithium metal alloy includes lithium and a metal selected from Na, K, Rb, Cs, Fr, Be, Mg, Ca, Sr, Si, Sb, Pb, In, Zn, Ba, Ra, Ge, Al, or Sn.

Examples of the material capable of doping and dedoping lithium include Si, SiOₓ (0<x<2), a Si-M alloy (where M is an element selected from the group consisting of an alkaline metal, an alkaline-earth metal, a group 13 element, a group 14 element, a group 15 element, a group 16 element, a transition element, a rare earth element, and combinations thereof, and is not Si), Sn, SnO₂, a Sn-M alloy (where M is an element selected from the group consisting of an alkaline metal, an alkaline-earth metal, a group 13 element, a group 14 element, a group 15 element, a group 16 element, a transition element, a rare earth element, and combinations thereof, and is not Sn), and mixtures thereof. At least one of these materials may be mixed with SiO₂. The element M is Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

Examples of the transition metal oxide include vanadium oxide, lithium vanadium oxide, or the like.

The rechargeable lithium battery may have no shortcomings related to the initial irreversible capacity of the negative active material and accomplish high capacity.

For example, when a graphite negative active material is used, a battery may have an irreversible reaction represented by Reaction Scheme 1 during the initial charge.

Li⁺+e⁻+Electrolyte→(Li-Electrolyte) [Reaction Scheme 1]

Herein, the produced [Li-Electrolyte] may form a solid electrolyte interface (SEI) film on the surface of a negative active material surface and work as an irreversible material, not using Li therein during the charge and discharge.

According to another embodiment, when used is a SiO negative active material, a battery may have an irreversible reaction represented by the following Reaction Scheme 2 during the initial charge cycle.

5SiO+6Li→Li₂O+Li₄SiO₄+4Si [Reaction Scheme 2]

Still another embodiment, when used is a negative active material such as Si, SiOₓ, and the like, nano cluster lithium oxide or lithium silicate surrounding Si after the initial charge and discharge may work as an irreversible material using no Li. The amount of the irreversible material may reach about 45% of maximum capacity (Journal of Power Sources 195 2010 6143-6147).

A positive active material including extra Li corresponding to the amount of irreversibly consumed Li in the initial reaction can be provided, but this in general deteriorates energy density of the positive active material. Accordingly, a positive active material may be mixed with a material that may compensate initial irreversibility and also, have high energy density and minimized mass and volume after lithium deintercalation to minimize energy density loss during the charge and discharge later. Herein, the lithium polysulfide may be usefully applied therein. When Li used in the initial irreversible reaction comes from a positive active material, the lithium polysulfide may compensate the Li.

For example, when Si, Sn, and the like is used as a negative active material, its irreversible capacity loss during the initial cycle (formation) is known to reach about 50% of the initial capacity (refer to Electrochemical and Solid-State Letters, 6 90 A194-A197 2003). Accordingly, Li may be consumed about 40 to 50% of maximum capacity in the initial irreversible reaction and about 50 to 60% of the capacity from the second cycle. Herein, when lithium polysulfide with big capacity per g is included in a positive active material, it may compensate the initial irreversible capacity. In addition, when lithium polysulfide is used in the formation process, its low rate characteristic itself may be used.

According to another embodiment, a rechargeable lithium battery may maintain excellent capacity and cycle characteristic by using lithium polysulfide as a positive additive to compensate initial irreversible capacity as well as have increased battery capacity by using a high-capacity negative active material. The high-capacity negative active material may be selected from the group consisting of, for example, graphite, silicon (Si), silicon-based oxide, silicon-based carbide, tin, tin-based oxide, and a combination thereof.

In a rechargeable lithium battery according to another embodiment, the negative active material layer may include a binder and optionally a conductive material.

The binder improves binding properties of the negative active material particles to each other and to a current collector. Examples of the binder include at least one polyvinylalcohol, carboxylmethylcellulose, hydroxypropylcellulose, polyvinylchloride, carboxylated polyvinylchloride, polyvinylfluoride, polymer including ethylene oxide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like, but are not limited thereto.

The conductive material is included to improve electrode conductivity. Any electrically conductive material may be used as a conductive material unless it causes a chemical change. Examples of the conductive material include a carbon-based material such as natural graphite, artificial graphite, carbon black, acetylene black, ketjen black, and a carbon fiber; a metal-based material such as a metal powder or a metal fiber including copper, nickel, aluminum, and silver; a conductive polymer such as a polyphenylene derivative; and a mixture thereof.

The current collector includes a copper foil, a nickel foil, a stainless steel foil, a titanium foil, a nickel foam, a copper foam, a polymer substrate coated with a conductive metal, or combinations thereof.

The positive electrode includes a current collector and a positive active material layer disposed on the current collector.

The current collector may include Al, but is not limited thereto.

The positive active material may include an active material capable of reversibly intercalating/deintercalating lithium and lithium polysulfide and is illustrated in detail as aforementioned.

After the lithium polysulfide compensates initial irreversible capacity, sulfur (S) is produced therefrom during the charge and discharge. The sulfur (S) reacts with Li at a low potential later and rather deteriorates energy density. In addition, sulfur ions may be dissolved in an electrolyte and work as impurities. Accordingly, the lithium polysulfide may be controlled regarding amount in terms of energy density. According to another embodiment, the amount of the positive active material included in the rechargeable lithium battery may be determined according to the following Equation 2.

Y:Z=D/E:[(A×B)/{(100−B)×C}]±20% [Equation 2]

In the above Equation 2,

Y indicates the amount of an active material capable of reversibly intercalating/deintercalating lithium, and Z indicates the amount of lithium polysulfide,

A indicates a capacity of negative active material (mAh) required in a battery, and the capacity of the negative active material refers to (N/P ratio) X battery capacity. For examples, in a battery with a capacity of 1.5 mAh, if N/P ratio is 1.1, the capacity of negative active material 1.65 mAh. The N/P ratio refers to a required amount of a negative active material to a positive electrode capacity.

B indicates a negative active material irreversible capacity ratio [%],

D indicates design capacity (mAh),

E indicates the theoretical capacity (mAh/g) of the active material capable of reversibly intercalating/deintercalating lithium, and

C indicates theoretical specific capacity (mAh/g) of lithium polysulfide. For example, since Li₂S has theoretical capacity of 1141.6 mAh/g, C=1141.6.

The amount of an active material capable of reversibly intercalating/deintercalating lithium is determined by D/E based on the entire battery capacity, and then, the amount of lithium polysulfide may be determined according to Equation 2.

For example, when lithium cobalt-based oxide is used as a positive active material, and Li₂S as an additive, the positive active material may include an active material capable of reversibly intercalating/deintercalating lithium and Li₂S in a ratio ranging from 94:6 to 91:9 to solve an initial irreversible capacity problem. Accordingly, it may ultimately solve irreversible capacity problem of a high-capacity negative electrode.

The negative and positive electrodes may be fabricated in a method including mixing the active material, a binder, and optionally, a conductive material to provide an active material composition, and coating the composition on a current collector followed by drying and compressing it. The electrode-manufacturing method is well known and thus is not described in detail in the present specification. The solvent includes N-methylpyrrolidone and the like, but is not limited thereto.

In a rechargeable lithium battery according one embodiment, the electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Examples of the ester-based solvent may include methyl acetate, ethyl acetate, n-propyl acetate, dimethyl acetate, methylpropionate, ethylpropionate, γ-butyrolactone, decanolide, valerolactone, mevalonolactone, caprolactone, and the like. Examples of the ether-based solvent include dibutyl ether, tetraglyme, diglyme, dimethoxyethane, 2-methyltetrahydrofuran, tetrahydrofuran, and the like, and examples of the ketone-based solvent include cyclohexanone and the like. Examples of the alcohol-based solvent include ethyl alcohol, isopropyl alcohol, and the like, and examples of the aprotic solvent include nitriles such as R—CN (where R is a C₂ to C₂₀ linear, branched, or cyclic hydrocarbon, a double bond, an aromatic ring, or an ether bond), amides such as dimethylformamide, dioxolanes such as 1,3-dioxolane, sulfolanes, and the like.

The non-aqueous organic solvent may be used singularly or in a mixture. When the organic solvent is used in a mixture, the mixture ratio can be controlled in accordance with a desirable battery performance.

The carbonate-based solvent may include a mixture of a cyclic carbonate and a linear carbonate. The cyclic carbonate and the linear carbonate are mixed together in a volume ratio of about 1:1 to about 1:9. When the mixture is used as an electrolyte, the electrolyte performance may be enhanced.

In addition, the non-aqueous organic electrolyte may further include the mixture of a carbonate-based solvent and an aromatic hydrocarbon-based solvent. The carbonate-based solvent and the aromatic hydrocarbon-based solvent may be mixed together in a volume ratio from about 1:1 to about 30:1.

The aromatic hydrocarbon-based organic solvent may be represented by the following Chemical Formula 1.

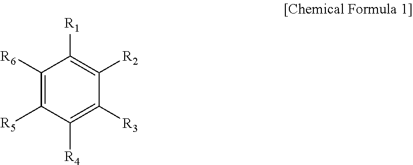

In Chemical Formula 1, R₁ to R₆ are independently selected from the group consisting of hydrogen, a halogen, a C1 to C10 alkyl group, a C1 to C10 haloalkyl group, and a combination thereof.

The aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof.

The non-aqueous electrolyte may further include vinylene carbonate, an ethylene carbonate-based compound of the following Chemical Formula 2, or a combination thereof in order to improve cycle life of a battery.

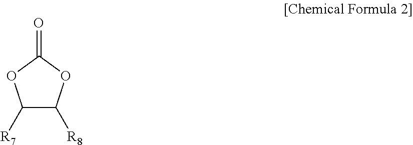

In Chemical Formula 2, R₇ and R₈ are independently hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group.

Examples of the ethylene carbonate-based compound include difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The use amount of the vinylene carbonate or the ethylene carbonate-based compound may be adjusted within an appropriate range.

The lithium salt is dissolved in an organic solvent, supplies lithium ions in the battery, operates basic operation of a rechargeable lithium battery, and improves lithium ion transport between positive and negative electrodes. Examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, and LiB(C₂O₄)₂ (lithium bisoxalato borate, LiBOB). The lithium salt may be used in a concentration ranging from about 0.1 M to about 2.0 M. When the lithium salt is included at the above concentration range, electrolyte performance and lithium ion mobility may be enhanced due to optimal electrolyte conductivity and viscosity.

The rechargeable lithium battery may further include a separator between the negative electrode and the positive electrode, as needed. Examples of suitable separator materials include polyethylene, polypropylene, polyvinylidene fluoride, and multi-layers thereof, such as a polyethylene/polypropylene double-layered separator, a polyethylene/polypropylene/polyethylene triple-layered separator, and a polypropylene/polyethylene/polypropylene triple-layered separator.

The following examples illustrate this disclosure in more detail. These examples, however, are not in any sense to be interpreted as limiting the scope of this disclosure.

### EXAMPLE

### Example 1

A LiCoO₂ positive active material (theoretical specific capacity: 150 mAh/g, diameter: 20 μm), a denka black conductive agent and a polyvinylidene fluoride binder was mixed in an N-methyl pyrrolidone solvent at a weight ratio of 92:4:4, to prepare a positive active material slurry. Li₂S (theoretical capacity: 1141.6 mAh/g, diameter: 1.66 μm, weight average molecular weight: 45.95) was added to the positive active material slurry. The amount of the Li₂S was 0.2 parts by weight based on 100 parts by weight of the positive active material.

The resulting positive active material slurry added with Li₂S was coated on an Al-foil current collector using a table coater, dried and then pressed, to produce a positive electrode.

A natural graphite negative active material and a polyvinylidene fluoride binder was mixed in an N-methyl pyrrolidone solvent at a weight ratio of 97.5:2.5, to prepare a negative active material slurry. The negative active material slurry was coated on a Cu-foil current collector using a table coater, dried, and then pressed, to produce a negative electrode.

A coin cell with a design capacity of 1.5 mAh, was fabricated using the positive electrode, the negative electrode, an electrolyte and a separator. As the electrolyte, a 1M LiPF6 dissolved in a mixed organic solvent of ethylene carbonate, ethyl methyl carbonate and dimethyl carbonate (3:3:4 volume ratio) was used. As the separator, a polyethylene separator was used.

In the coin cell, a N/P ratio was set to 1.1.

### Example 2

A coin cell was fabricated by the same procedure as in Example 1, except that the amount of Li₂S added to the positive active material slurry was changed to 0.4 parts by weight based on 100 parts by weight of the positive active material.

### Example 3

A coin cell was fabricated by the same procedure as in Example 1, except that the amount of Li₂S added to the positive active material slurry was changed to 0.6 parts by weight based on 100 parts by weight of the positive active material.

### Example 4

A coin cell was fabricated by the same procedure as in Example 1, except that the amount of Li₂S added to the positive active material slurry was changed to 0.8 parts by weight based on 100 parts by weight of the positive active material.

### Example 5

A coin cell was fabricated by the same procedure as in Example 1, except that the amount of Li₂S added to the positive active material slurry was changed to 1.0 parts by weight based on 100 parts by weight of the positive active material.

### Example 6

A coin cell was fabricated by the same procedure as in Example 1, except that the amount of Li₂S added to the positive active material slurry was changed to 1.2 parts by weight based on 100 parts by weight of the positive active material.

### Example 7

A coin cell was fabricated by the same procedure as in Example 1, except that the amount of Li₂S added to the positive active material slurry was changed to 1.4 parts by weight based on 100 parts by weight of the positive active material.

### Example 8

A coin cell was fabricated by the same procedure as in Example 1, except that the amount of Li₂S added to the positive active material slurry was changed to 1.6 parts by weight based on 100 parts by weight of the positive active material.

### Example 9

A coin cell was fabricated by the same procedure as in Example 1, except that the amount of Li₂S added to the positive active material slurry was changed to 1.8 parts by weight based on 100 parts by weight of the positive active material.

### Example 10

A coin cell was fabricated by the same procedure as in Example 1, except that the amount of Li₂S added to the positive active material slurry was changed to 2.0 parts by weight based on 100 parts by weight of the positive active material.

### Comparative Example 1

A coin cell was fabricated by the same procedure as in Example 1, except that Li₂S was not added to the positive active material.

The coin cells according to Examples 1 to 10 and Comparative Example 1 was charged and discharged under an initial formation condition. The initial formation condition was charged at 0.1 C to 4.3V using a CC/CV (constant current/constant voltage) mode, and then discharged at 0.1 C to3.0V using a CC mode for once.

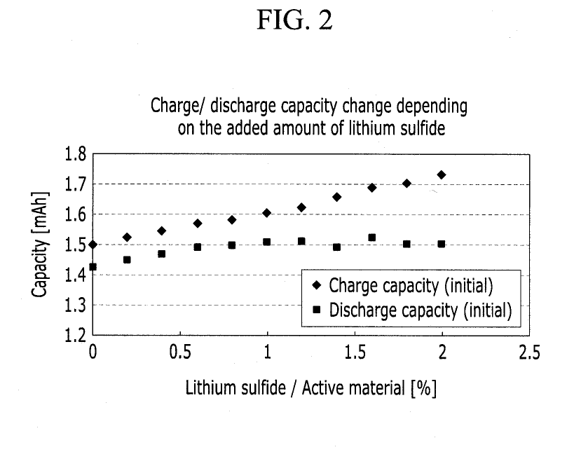

The charge and discharge capacities according to the initial formation were measured and the results are shown in FIG. 2.

As shown in FIG. 2, the cells according to Examples 1 to 10 with an addition of polysulfide exhibited improved charge capacities and discharge capacities, compared to the cells according to Comparative Example 1 without polysulfide. Furthermore, , the cells according to Examples 3 to 10, may have increased charge capacity and desired discharge capacity (design capacity) despite the same amount of a lithium cobalt oxide.

In especially, the cells according to Examples 3 and 4 including lithium polysulfide with the range of Equation 2 may have increased charge capacity but no increased discharge capacity due to sulfur loss into an electrolyte or irreversible reaction after the charge. In addition, when the lithium polysulfide is restricted to have a diameter range of Equation 1, it may not be included in more volume to compensate initial irreversible reaction. The same give volume of the lithium polysulfide may solve irreversible capacity.

While this disclosure has been described in connection with what is presently considered to be practical example embodiments, it is to be understood that the embodiments are not limited to the disclosed embodiments, but, on the contrary, is intended to cover various modifications and equivalent arrangements included within the spirit and scope of the appended claims.

What is claimed is:

1. A positive active material for a rechargeable lithium battery comprising:
an active material capable of reversibly intercalating/deintercalating lithium; and
a lithium polysulfide.

2. The positive active material of claim 1, wherein the lithium polysulfide is Li₂Sₓ (x is an integer of 1 to 8).

3. The positive active material of claim 1, wherein the active material capable of reversibly intercalating/deintercalating lithium comprises LiₐA_{1-b}R_{b}D₂ (wherein, in the above formula, 0.90≦a≦1.8 and 0≦b≦0.5); LiₐE_{1-b}R_{b}O_{2-c}D_{c} (wherein, in the above formula, 0.90≦a≦1.8, 0≦b≦0.5 and 0≦c≦0.05); LiE_{2-b}R_{b}O_{4-c}D_{c} (wherein, in the above formula, 0≦b≦0.5, 0≦c≦0.05); LiₐNi_{1-b-c}Co_{b}R_{c}D_{α} (wherein, in the above formula, 0.90≦a≦1.8, 0≦b≦0.5, 0≦c≦0.05 and 0<α≦2); LiₐNi_{1-b-c}Co_{b}R_{c}O_{2-α}Z_{α} (wherein, in the above formula, 0.90≦a≦1.8, 0≦b≦0.5, 0≦c≦0.05 and 0<α<2); LiₐNi_{1-b-c}Co_{b}R_{c}O_{2-α}Z₂ (wherein, in the above formula, 0.90≦a≦1.8, 0≦b≦0.5, 0≦c≦0.05 and 0<α<2); LiₐNi_{1-b-c}Mn_{b}R_{c}D_{α} (wherein, in the above formula, 0.90≦a≦1.8, 0≦b≦0.5, 0≦c≦0.05 and 0<α≦2); LiₐNi_{1-b-c}Mn_{b}R_{c}O_{2-α}Z_{α} (wherein, in the above formula, 0.90≦a≦1.8, 0≦b≦0.5, 0≦c≦0.05 and 0<α≦2); LiₐNi_{1-b-c}Mn_{b}R_{c}O_{2-α}Z₂ (wherein, in the above formula, 0.90≦a≦1.8, 0≦b≦0.5, 0≦c≦0.05 and 0<α<2); LiₐNi_{b}E_{c}G_{d}O₂ (wherein, in the above formula, 0.90≦a≦1.8, 0≦b≦0.9, 0≦c≦0.5 and 0.001≦d≦0.1); LiₐNi_{b}Co_{c}Mn_{d}GeO₂ (wherein, in the above formula, 0.90≦a≦1.8, 0≦b≦0.9, 0≦c≦0.5, 0≦d≦0.5 and 0.001≦e≦0.1); LiₐNiG_{b}O₂ (wherein, in the above formula, 0.90≦a≦1.8 and 0.001≦b≦0.1); LiₐCoG_{b}O₂ (wherein, in the above formula, 0.90≦a≦1.8 and 0.001≦b≦0.1); LiₐMnG_{b}O₂ (wherein, in the above formula, 0.90≦a≦1.8 and 0.001≦b≦0.1); LiₐMn₂G_{b}O₄ (wherein, in the above formula, 0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); LiFePO₄, or a combination thereof,
wherein, in the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

4. The positive active material of claim 1, wherein the active material capable of reversibly intercalating/deintercalating lithium comprises an oxide comprising lithium and cobalt, an oxide comprising lithium and manganese, or a combination thereof.

5. The positive active material of claim 1, wherein the lithium polysulfide particle has a diameter (X) satisfying the following Equation 1:
2r(\sqrt{2}−1)≦X≦2r(\sqrt{2}−1)+2r(\sqrt{2}−1)×K [Equation 1]
wherein, in the above Equation 1,
r is the radius of the active material capable of reversibly intercalating/deintercalating lithium, and K is the volume reduction ratio when lithium polysulfide becomes sulfur.

6. The positive active material of claim 1, wherein the lithium polysulfide has a weight average molecular weight of from about 45.95 to about 270.40.

7. A rechargeable lithium battery comprising:
a negative electrode comprising a negative active material; and
a positive electrode comprising a positive active material comprising: an active material capable of reversibly intercalating/deintercalating lithium;
a lithium polysulfide.

8. The rechargeable lithium battery of claim 7, wherein the lithium polysulfide is Li₂Sₓ (x is an integer of 1 to 8).

9. The rechargeable lithium battery of claim 7, wherein the active material capable of reversibly intercalating/deintercalating lithium comprises LiₐA_{1-b}R_{b}D₂ (wherein, in the above formula, 0.90≦a≦1.8 and 0≦b≦0.5); LiₐE_{1-b}R_{b}O_{2-c}D_{c} (wherein, in the above formula, 0.90≦a≦1.8, 0≦b≦0.5 and 0≦c≦0.05); LiE_{2-b}R_{b}O_{4-c}D_{c} (wherein, in the above formula, 0≦b≦0.5, 0≦c≦0.05); LiₐNi_{1-b-c}Co_{b}R_{c}D_{α} (wherein, in the above formula, 0.90≦a≦1.8, 0≦b≦0.5, 0≦c≦0.05 and 0<α≦2); LiₐNi_{1-b-c}Co_{b}R_{c}O_{2-α}Z_{α} (wherein, in the above formula, 0.90≦a≦1.8, 0≦b≦0.5, 0≦c≦0.05 and 0<α<2); LiₐNi_{1-b-c}Co_{b}R_{c}O_{2-α}Z₂ (wherein, in the above formula, 0.90≦a≦1.8, 0≦b≦0.5, 0≦c≦0.05 and 0<α<2); LiₐNi_{1-b-c}Mn_{b}R_{c}D_{α} (wherein, in the above formula, 0.90≦a≦1.8, 0≦b≦0.5, 0≦c≦0.05 and 0<α≦2); LiₐNi_{1-b-c}Mn_{b}R_{c}O_{2-α}Z_{α} (wherein, in the above formula, 0.90≦a≦1.8, 0≦b≦0.5, 0≦c≦0.05 and 0<α<2); LiₐNi_{1-b-c}Mn_{b}R_{c}O_{2-α}Z₂ (wherein, in the above formula, 0.90≦a≦1.8, 0≦b≦0.5, 0≦c≦0.05 and 0<α<2); LiₐNi_{b}E_{c}G_{d}O₂ (wherein, in the above formula, 0.90≦a≦1.8, 0≦b≦0.9, 0≦c≦0.5 and 0.001≦d≦0.1); LiₐNi_{b}Co_{c}Mn_{d}GeO₂ (wherein, in the above formula, 0.90≦a≦1.8, 0≦b≦0.9, 0≦c≦0.5, 0≦d <0.5 and 0.001≦e≦0.1); LiₐNiG_{b}O₂ (wherein, in the above formula, 0.90≦a≦1.8 and 0.001≦b≦0.1); LiₐCoG_{b}O₂ (wherein, in the above formula, 0.90≦a≦1.8 and 0.001≦b≦0.1); LiₐMnG_{b}O₂ (wherein, in the above formula, 0.90≦a≦1.8 and 0.001≦b≦0.1); LiₐMn₂G_{b}O₄ (wherein, in the above formula, 0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); LiFePO₄, or a combination thereof,
wherein, in the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

10. The rechargeable lithium battery of claim 7, wherein the active material capable of reversibly intercalating/deintercalating lithium comprises an oxide comprising lithium and cobalt, an oxide comprising lithium and manganese, or a combination thereof.

11. The rechargeable lithium battery of claim 7, wherein the lithium polysulfide particle has a diameter (X) satisfying the following Equation 1:
2r(\sqrt{2}−1)≦X≦2r(\sqrt{2}−1)+2r(\sqrt{2}−1)×K [Equation 1]
wherein, in the above Equation 1,
r is the radius of the active material capable of reversibly intercalating/deintercalating lithium, and K is the volume reduction ratio when lithium polysulfide becomes sulfur.

12. The rechargeable lithium battery of claim 7, wherein the lithium polysulfide has a weight average molecular weight of from about 45.95 to about 270.40.

13. The rechargeable lithium battery of claim 7, wherein the positive active material comprises the active material capable of reversibly intercalating/deintercalating lithium and the lithium polysulfide in a weight ratio according to the following Equation 2:
Y:Z=D/E:[(A×B)/{(100−B)×C}]±20% [Equation 2]
wherein, in the above Equation 2,
Y indicates the amount of the active material capable of reversibly intercalating/deintercalating lithium, and Z indicates the amount of the lithium polysulfide,
A indicates negative active material capacity (mAh) required inside a battery, B indicates a negative active material irreversible capacity ratio (%), D indicates design capacity (mAh), E indicates the theoretical specific capacity (mAh/g) of an active material capable of reversibly intercalating/deintercalating lithium, and C indicates theoretical capacity (mAh/g) of lithium polysulfide.

14. The rechargeable lithium battery of claim 13, wherein the negative active material is selected from the group consisting of graphite, silicon (Si), silicon-based oxide, tin, tin-based oxide, and a combination thereof.

15. The rechargeable lithium battery of claim 7, wherein the non- aqueous electrolyte comprises a non-aqueous organic solvent and a lithium salt.

16. The rechargeable lithium battery of claim 15, wherein the non-aqueous organic solvent is at least one selected from the group consisting of a carbonate-based solvent, ester-based solvent, ether-based solvent, ketone-based solvent, alcohol-based solvent, or aprotic solvent.
